(19) United States
(12) Patent Application Publication
(10) Pub. No.: US 2025/0276830 A1
(43) Pub. Date: Sep. 4, 2025

(54) REMOVABLE CLIP

(71) Applicant: UFP Industries, Inc., Grand Rapids, MI (US)

(72) Inventors: Robert Bilbrough, Ada, MI (US); Matthew Michael Costigan, Lowell, MI (US); Riley Charles True, Grand Rapids, MI (US); Nicholas Lee Martinchek, Grand Rapids, MI (US)

(73) Assignee: UFP Industries, Inc., Grand Rapids, MI (US)

(21) Appl. No.: 19/213,255

(22) Filed: May 20, 2025

Related U.S. Application Data
(63) Continuation-in-part of application No. PCT/US2023/081595, filed on Nov. 29, 2023.

(51) Int. Cl. B65D 21/08; F16B 2/22

(52) U.S. Cl. CPC B65D 21/086; F16B 2/22

(57) ABSTRACT

A removable clip for fastening together a first piece adjacent to a second piece to form a portion of a crate. The removable clip includes a body. The body includes a first arm, a second arm coupled to the first arm, a third arm coupled to the second arm, a fourth arm coupled to the third arm, a fifth arm, and a sixth arm provided on the fifth arm between a first distal end and a second distal end. A first channel receives the first piece and a second channel receives the second piece.

### CROSS REFERENCE

This application is a continuation-in-part of International Patent Application No. PCT/US2023/081595 filed on Nov. 29, 2023, all of which is incorporated herein by reference in its entirety.

### BACKGROUND

Crates, also known as containers or boxes, have been used for centuries to move materials or goods from one location to another. When carrying heavy loads, boxes are often made from increasingly stronger materials such as wood or metal. Often the sides of the crate that define a protected or enclosed volume are secured to one another by means of nails, screws, or tightening bands requiring specific tools to remove. Optionally, these crates can be secured to wooden pallets, allowing the use of machines to move the crate.

Traditionally, crates are designed for single use and disposed of after the transported materials or goods have reached their destination. However, due to financial, environmental and/or safety reasons, reusable collapsible crates have been developed and are increasingly used for transporting materials and goods.

### BRIEF DESCRIPTION OF THE DRAWINGS

In the drawings:

FIG. 1 is a perspective view of an assembled reusable crate with a plurality of clips.

FIG. 2 is a perspective view of a clip of the plurality of clips of FIG. 1 according to aspects of the present disclosure.

FIG. 3 is a cross-sectional view of the clip of FIG. 2 according to aspects of the present disclosure.

FIG. 4 is a cross-sectional view of the clip of FIG. 2 and FIG. 3 coupling adjacent pieces according to aspects of the present disclosure.

FIG. 5 is a variation of the cross-sectional view of FIG. 3 according to aspects of the present disclosure.

FIG. 6 is a variation of the perspective view of FIG. 2 according to aspects of the present disclosure.

FIG. 7 is a cross-sectional view of the clip of FIG. 6 according to aspects of the present disclosure.

FIG. 8 is a cross-sectional view of the clip of FIG. 6 and FIG. 7 coupling adjacent pieces according to aspects of the present disclosure.

### DETAILED DESCRIPTION

Collapsible or reusable crates provide the greatest benefit when designed to be easily assembled to form small or large containers by a single person without the use of nails, a hammer, or other traditional tools and equipment traditionally associated with assembling crates.

The present disclosure relates to a removable clip for a knock-down structure, and more particularly, to a removable clip for use to secure adjacent pieces of a collapsible container to one another. As disclosed herein, a clip releasably couples two adjacent pieces of a reusable crate. That is, side walls of the reusable crate are connected to one other and to a base using a plurality of removable clips. A lid can then be coupled to one or more of the side walls. The base can be formed with or coupled to a skid, such that, when assembled, the reusable crate can be handled by a machine, such as a forklift.

The removable clips are tool-free. As used herein, the term “tool-free” defines the assembly, application, mounting, fastening, or construction of an object or portions of the object without the use of tools, such as, but not limited to a hammer, screw driver, drill, or pry bar.

Since the removable clips are tool-free, the reusable crate can be assembled by a single person using the removable clips without any tools. Further the single person can also disassemble the reusable crate by the removal of the clips without the use of tools.

As used herein, the term “piece” is anything that can be used to form at least a portion of a container. For example, a piece can be lumber approximately 2 inches by 4 inches as sawed and usually 1.5 inches by 3.5 inches when dressed. By way of further non-limiting example, a piece can be lumber approximately 1 inch by 2 inches, 2 inches by 6 inches, 4 inches by 4 inches, or 2 inches by 8 inches, as sawed. Further, a piece can include or be a panel, a plywood sheet, or a portion of a plywood sheet having a thickness, for example, of 0.125, 0.25, 0.375, 0.5, 0.625, 0.75, 1.125, or 1.25 inches. While illustrated as lumber, a piece can have any dimensions and be made entirely from or include portions of that are plastic, wood, or metal.

Each removable clip generally has a G-shape formed by at least five arms. The five arms, along with a sixth arm or spur arm, contact the two adjacent pieces at six surfaces. A finger grip defined by a portion of one of the arms allows for easy removal of the removable clip. A radiused or rounded portion of the sixth arm eases fastening of the removable clip to the two pieces.

All directional references (e.g., proximal, distal, upper, lower, upward, downward, left, right, lateral, front, back, top, bottom, above, below, vertical, horizontal, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, and connected,) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

While “a set of” or “a plurality of” various elements will be described, it will be understood that “a set” or “a plurality” can include any number of the respective elements, including only one element.

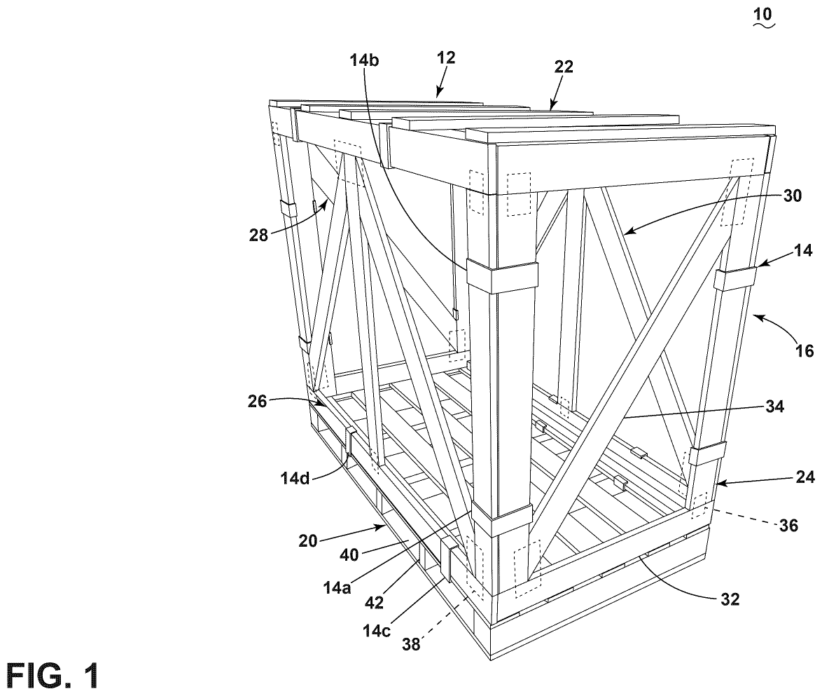

FIG. 1 illustrates a perspective view of a collapsible or reusable crate assembly 10 in an assembled state. The reusable crate assembly 10 includes a set of pieces 12 and a plurality of removable clips 14. The set of pieces 12 are illustrated, by way of example, as a base piece 20, a lid piece 22, a first side piece 24, a second side piece 26, a third side piece 28, and a fourth side piece 30. The first side piece 24, the second side piece 26, the third side piece 28, and the fourth side piece 30 can extending between the base piece 20 and the lid piece 22. While illustrated as having four side pieces, any number of side pieces are contemplated, such as, but not limited to, three, five, or six.

Each piece of the set of pieces 16 can include a frame 32. The frame 32 can define a perimeter of the piece. Optionally, one or more cross members 34 can couple two or more portions of the frame 32. The frame 32, as illustrated by way of example, can defined by a set of frame pieces coupled together by one or more fasteners 36. Other fasteners 38 can couple the one or more cross members 34 to portions of the frame 32 and/or couple together adjacent portions of the frame 32.

Each removable clip of the plurality of removable clips 14 couples together two adjacent pieces. While two removable clips of the plurality of removable clips 14 are illustrated as coupling adjacent pieces of the set of pieces 16, any number of removable clips are contemplated. Depending on a size of the reusable crate assembly 10 a single removable clip could be utilized to couple together two adjacent pieces.

As illustrated, by way of example, a first removable clip 14a and a second removable clip 14b of the plurality of removable clips 14 fasten the first side piece 24 and the second side piece 26. By way of further non-limiting example, a third removable clip 14c and a fourth removable clip 14d couple the second side piece 26 to the base piece 20.

The base piece 20 is illustrated, by way of example, as a pallet having receiving portions 40 between vertical supports 42, where the receiving portions 40 can receive one or more machines such as, but not limited to one or more of a forklift, a pallet jack, a front loader, a jacking device, or an erect crane.

The set of pieces 16 can be formed from a variety of materials, including, but not limited to one or more of wood, plastic, metal, natural fibers, composite, or recycled material. By way of non-limiting example, the wood can be one or more of hardwoods like hickory, mahogany, maple, oak, teak, and walnut, or softwoods like various types of pine. Each piece of the set of pieces 16 can include different materials or different combinations or ratios of materials.

While illustrated as open, one or more pieces of the set of pieces 16 can include one or more sheets of material that couple to the frame 32, one or more cross members 34, or both the frame 32 and the one or more cross member 34. The sheets of material can include cut-outs, recesses, or flex in a way that the plurality of removable clips 14 can still couple the frames 32 of adjacent pieces of the set of pieces 16.

The set of pieces 16 can include lumber approximately 2 inches by 4 inches as sawed and usually 1.5 inches by 3.5 inches when dressed. By way of further non-limiting example, the set of pieces 16 can include lumber approximately 1 inch by 2 inches, 2 inches by 6 inches, 4 inches by 4 inches, 2 inches by 8 inches, 2 inches by 10 inches, or 2 inches by 12 inches as sawed. Further, the set of pieces 16 can include a panel, a plywood sheet, or a portion of a plywood sheet having a thickness, for example, of 0.125, 0.25, 0.375, 0.5, 0.625, 0.75, 1.125, or 1.25 inches. As illustrated, by way of example, the dimensions each piece of the set of pieces 16 can vary. Therefore, the removable clip 14 can have a varying profile with varying arm lengths that depend on dimensions of the pieces used to form the reusable crate assembly 10.

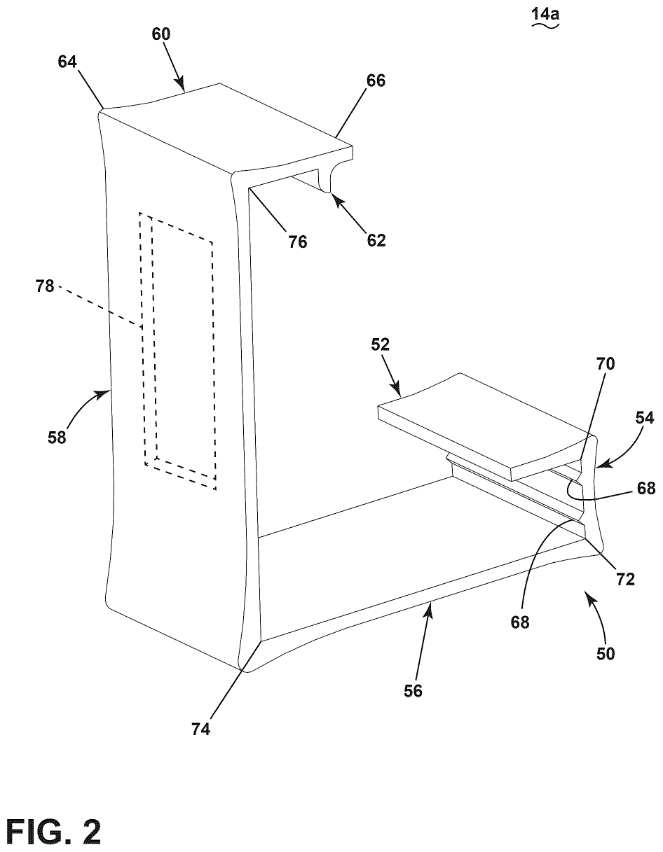

FIG. 2 is a perspective view of the first removable clip 14a of the plurality of removable clips 14. The first removable clip 14a is similar to the other removable clips of the plurality of removable clips 14 and hereinafter will be referred to as the removable clip 14a.

The removable clip 14a has a body 50. The body 50 includes a first arm 52, a second arm 54 extending from to the first arm 52, a third arm 56 extending from the second arm 54, a fourth arm 58 extending from the third arm 56, a fifth arm 60 extending from the fourth arm 58, and a spur arm or a sixth arm 62 provided on the fifth arm 60. The fifth arm 60 includes a first distal end 64 where it intersects with the fourth arm 58, and a second distal end 66, which is a free end. The sixth arm 62 extends from the fifth arm 60 at a portion that is between the first distal end 64 and the second distal end 66. The first arm 52, the second arm 54, the third arm 56, the fourth arm 58, and the fifth arm 60 form a G-shaped clip.

Optionally, a set of spurs 68 can be provided extending from an interior side of the second arm 54. While illustrated as having two spurs in the set of spurs 68, the set of spurs 68 can include any number of spurs. Further, while illustrated as extending from the second arm 54, it is contemplated that the first arm 52, third arm 56, fourth arm 58, fifth arm 60, and/or sixth arm 62 could include one or more spurs.

A first corner 70 is defined in the body 50 where the first arm 52 extends from the second arm 54. That is, the first corner 70 is located at the intersection of the first arm 52 and the second arm 54. A second corner 72 is defined in the body 50 where the second arm 54 extends from the third arm 56. That is, the second corner 72 is located at the intersection of the second arm 54 and the third arm 56. A third corner 74 is defined in the body 50 where the third arm 56 extends from the fourth arm 58. That is, the third corner 74 is located at the intersection of the third arm 56 and the fourth arm 58. A fourth corner 76 is defined in the body 50 where the fourth arm 58 extends from the fifth arm 60. That is, the third corner 74 is located at the intersection of the fourth arm 58 and the fifth arm 60.

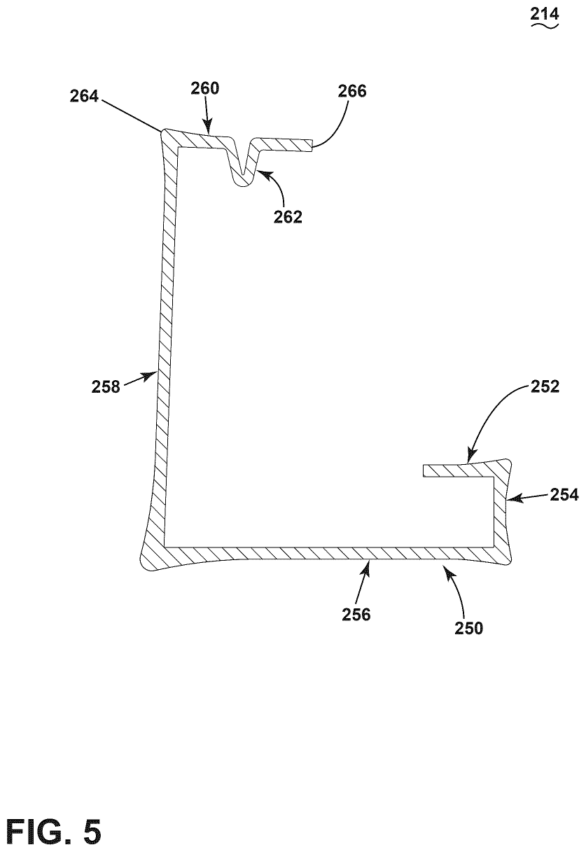

The removeable clip 14a can be unitary body or unitarily formed. That is, the body 50 can be a unitary monolithic body. It is contemplated that the body 50 can be formed by molded plastic. Further, it is contemplated that the body 50 can include at least one polymer. Additionally, or alternatively, the body 50 of the removeable clip 14a can include one or more of metal (e.g., steel, aluminum) or natural fiber where natural fiber can be produced by geological processes or from the bodies of plants or animals. It is contemplated that the features of the body 50 may be formed from a singular piece of metal such a wire, as further illustrated in FIG. 5.

It is further contemplated that each removable clip of the plurality of removable clips 14 (FIG. 1) can be made from the same material. Alternatively, one or more removable clip of the plurality of removable clips 14 (FIG. 1) can include different material(s) or different proportions of materials.

Optionally, the body 50 can include a window 78. While illustrated as a single window 78 in the fourth arm 58, any number of windows located in any one or more arms is contemplated. The window 78 can be a recessed portion or extend through the body 50. It is further contemplated that one or more windows can extend around corners. That is, the window 78 can extend from at least one arm to another.

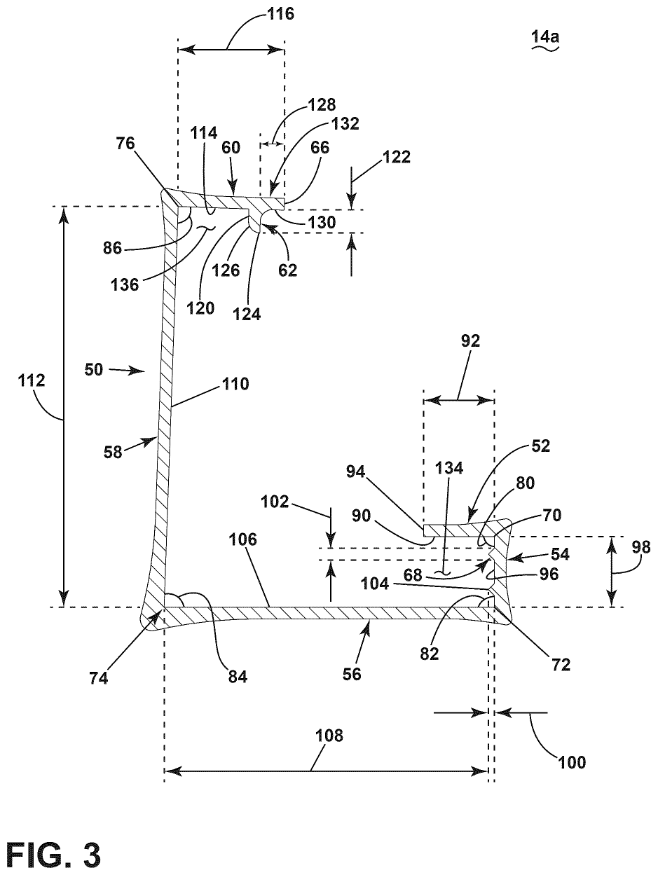

FIG. 3 is a cross sectional view of the removable clip 14a further illustrating the body 50. The first corner 70 defines a first angle 80, the second corner 72 defines a second angle 82, the third corner 74 defines a third angle 84, and the fourth corner 76 defines a fourth angle 86. The first angle 80, the second angle 82, the third angle 84, and the fourth angle 86 are between 10 degrees and 110 degrees. The third angle 84 can be in a range from 20 degrees to less than 90 degrees. By way of example, the third angle 84 can be in a range from 70 degrees to less than 90 degrees.

A first surface 90 is defined by an interior portion of the first arm 52. A length, illustrated as a first arm length 92, of the first arm 52 is measured from a first free end 94 to the first corner 70. By way of non-limiting example, the first arm length 92 can be measured along the first surface 90.

A second surface 96 is defined by an interior portion of the second arm 54. A length, illustrated as a second arm length 98, of the second arm 54 is measured from the first corner 70 to the second corner 72. By way of non-limiting example, the second arm length 98 can be measured along the second surface 96.

The second arm length 98 can be determined by a first thickness of a first piece of the two adjacent pieces to be held together by the removeable clip 14a. By way of non-limiting example, the second arm length 98 can be within 5% or less of the first thickness. That is, the second arm length 98 can be within 5% or less of a finished or dressed first thickness of the first piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches.

As illustrated, by way of non-limiting example, the first arm length 92 and the second arm length 98 can be equal. As used herein “equal” means that the percent difference between the two values is 5% or less. Alternatively, in a different and non-limiting example, the first arm length 92 can be greater than the second arm length 98. That is, the first arm length 92 can be more than 5% greater than the second arm length 98. In yet another different and non-limiting example, the second arm length 98 can be more than 5% greater than the first arm length 92.

The set of spurs 68 are illustrated, by way of example, as located between the first corner 70 and the second corner 72. Each spur of the set of spurs 68 can include a spur height 100 and a spur width 102. The spur height 100 is measure from the surface from which the spur extends, illustrated as the second surface 96 to a spur peak 104 or portion of the spur extending farthest from the second surface 96. The spur height 100 can be in a range from 2% to 30% of the second arm length 98. For example, the spur height 100 can be in a range from 5% to 20% of the second arm length 98. In another non-limiting example, the spur height 100 can be less than 15% of the second arm length 98.

The spur width 102 can be measured along the second surface 96. The spur width 102 is the distance between the two points at which the spur intercepts the second surface 96.

The spur width 102 can be in a range from 2% to 50% of the second arm length 98. For example, the spur width 102 can be in a range from 10% to 30% of the second arm length 98. It is further contemplated that the spur width 102 can be in a range from 25% to 150% of the spur height 100. For example, the spur width 102 can be in a range from 40% to 60% of the spur height 100.

A third surface 106 is defined by an interior portion of the third arm 56. A length, illustrated as a third arm length 108, of the third arm 56 is measured from the second corner 72 to the third corner 74. By way of non-limiting example, the third arm length 108 can be measured along the third surface 106.

As illustrated, by way of non-limiting example, the third arm length 108 is greater than the first arm length 92 and the second arm length 98. It is contemplated that, for example, the third arm length 108 can be two to ten times longer than the first arm length 92.

Alternatively, in a different and non-limiting example, the third arm length 108 can be equal to the first arm length 92 or the second arm length 98. In yet another different and non-limiting example, the third arm length 108 can be more than 5% less than the first arm length 92, the second arm length 98, or both the first arm length 92 and the second arm length 98.

The third arm length 108 can be determined by a first width of the first piece of the two adjacent pieces to be held together by the removeable clip 14a. By way of non-limiting example, the third arm length 108 can be within 5% or less of the first width of the first piece. That is, the third arm length 108 can be within 5% or less of a finished or dressed first width of the first piece that can be, for example, 0.25, 0.5, 0.75, 1.0, 1.5, 3.5, 5.5, 7.25, 9.25, or 11.25 inches.

A fourth surface 110 is defined by an interior portion of the fourth arm 58. A length, illustrated as a fourth arm length 112, of the fourth arm 58 is measured from the third corner 74 to the fourth corner 76. By way of non-limiting example, the fourth arm length 112 can be measured along the fourth surface 110.

As illustrated, by way of non-limiting example, the fourth arm length 112 is greater than the third arm length 108, the second arm length 98, and the first arm length 92. Although this need not be the case. It is contemplated that, for example, the fourth arm length 112 can be two to ten times longer than the first arm length 92.

The fourth arm length 112 can be determined by a second width of a second piece of the two adjacent pieces to be held together by the removeable clip 14a. By way of non-limiting example, the fourth arm length 112 can be within 5% or less of the second width of the second piece plus the first thickness of the first piece. That is, fourth arm length 112 can be within 5% or less of a finished or dressed second width of the second piece that can be, for example, 0.25, 0.5, 0.75, 1.0, 1.5, 3.5, 5.5, 7.25, 9.25, or 11.25 inches added to the first thickness of the first piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches.

A fifth surface 114 is defined by an interior portion of the fifth arm 60. A length, illustrated as a fifth arm length 116, of the fifth arm 60 is measured from the fourth corner 76 to the second distal end 66 of the fifth arm 60. By way of non-limiting example, the fifth arm length 116 can be measured along the fifth surface 114.

By way of non-limiting example, the fifth arm length 116 can be between 50% and 250% of the first arm length 92. As illustrated, by way of non-limiting example, the fifth arm length 116 can be in a range from 100% to 250% of the first arm length 92. Further, the fifth arm length 116 is also illustrated, by way of example, as less than the third arm length 108.

The fifth arm length 116 can be determined by a second thickness of the second piece of the two adjacent pieces to be held together by the removeable clip 14a. By way of non-limiting example, the fifth arm length 116 can be within 5% or less of the second thickness. That is, fifth arm length 116 can be within 5% or less of a finished or dressed second thickness of the second piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches.

A sixth surface or spur surface 120 is defined by an interior portion of the sixth arm 62. A length, illustrated as a sixth arm length 122, of the sixth arm 62 is measured from the fifth surface 114 to a free end 124. The sixth arm length 122 is greater than the spur height 100.

The sixth arm length 122 is in a range of 5% to 100% of the first arm length 92. For example, the sixth arm length 122 can be in a range of 5% to 75%, 10% to 50%, 10% to 40%, 15% to 80% or 20% to 70% of the first arm length 92.

Further, it is contemplated that the sixth arm length 122 is in a range of 5% to 100% of the fifth arm length 116. For example, the sixth arm length 122 can be in a range of 5% to 75%, 10% to 50%, 20% to 80%, or 40% to 60% of the fifth arm length 116.

Over the sixth arm length 122, the spur surface 120 can include a curved portion 126. The curved portion 126 of the spur surface 120 has a radius of curvature greater than zero. The curved portion 126 defines at least a portion of the free end 124.

An inset length 128 is defined as the length between the second distal end 66 of the fifth arm 60 and an outer portion 130 of the sixth arm 62.

A finger grip 132 is defined by a portion of the fifth arm 60 between the outer portion 130 of the sixth arm 62 and the second distal end 66. The finger grip 132 can includes a portion adjacent the outer portion 130. The finger grip 132 can have a radius of curvature greater than zero. The finger grip 132 has a length illustrated as the inset length 128.

A first channel 134 is defined by the first arm 52, the second arm 54, and the third arm 56. A second channel 136 is defined by the fourth arm 58, the fifth arm 60, and the sixth arm 62.

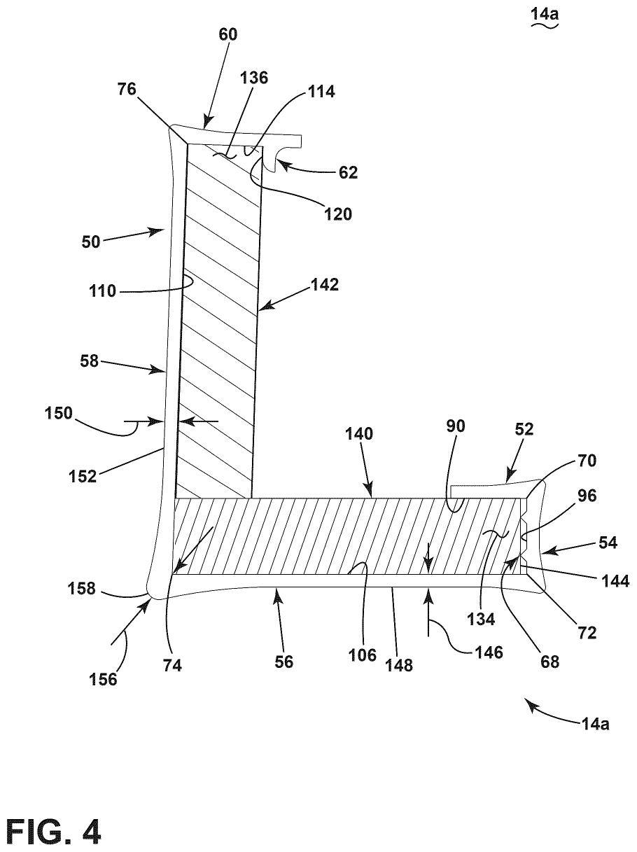

FIG. 4 further illustrates the removable clip 14a in a mounted position or assembled with a first piece 140 and a second piece 142. That is, the removable clip 14a is coupling adjacent frames 32 (FIG. 1) illustrated as a first piece 140 and a second piece 142, adjacent to the first piece 140. The first channel 134 receives the first piece 140. In other words, when the removable clip 14a is coupling the first piece 140 and the second piece 142, the first surface 90, the second surface 96 and the third surface 106 are adjacent portions the first piece 140. As used herein, the term “adjacent” means that a surface of one object is facing, next to, or in contact with a surface of a second object.

The second channel 136 receives the second piece 142. In other words, when the removable clip 14a is coupling the first piece 140 and the second piece 142, the fourth surface 110, the fifth surface 114, and the spur surface 120 are adjacent, facing, and/or in contact with portions the second piece 142.

The first piece 140 includes a piece distal end 144 that is received by the first channel 134. When the removable clip 14a is fastened to the first piece 140 and the second piece 142, the set of spurs 68 can be in contact with the piece distal end 144. Alternatively, the set of spurs 68 can pierce, detent, or extend into the first piece 140 past the piece distal end 144. Additionally, or alternatively, the piece distal end 144 contacts the second surface 96.

A third wall thickness 146 can be measured from the third surface 106 to an outer surface 148 of the third arm 56. Similarly, a fourth wall thickness 150 can be measured from the fourth surface 110 to an outer surface 152 of the fourth arm 58. A third corner thickness 156 can be measured from the intersection of the third surface 106 and the fourth surface 110 to an outer surface 158 of the third corner 74. The third corner thickness 156 can be greater than the third wall thickness 146 and the fourth wall thickness 150. That is, the body 50 can included thickened portions at the third corner 74. Further, as illustrated by way of example, the body 50 can included thickened portions at the first corner 70, the second corner 72, the third corner 74, and the fourth corner 76. It is contemplated that any or all of the first corner 70, the second corner 72, the third corner 74, or the fourth corner 76 can include additional material or thickened portions. The thickened portions can be formed as part of the monolithic body 50. Alternatively, the additional material or thickened portions can be coupled to the body 50 at any location.

Referring to FIG. 1-FIG. 4, in operation, to assemble the reusable crate assembly 10, the base piece 20 can receive one or more side pieces. Building or assembly of the reusable crate assembly 10 can be completed by a single person without tools. The side pieces can be fastened to the base piece 20 using one or more removable clips from the plurality of removable clips 14. By way of non-limiting example, a portion of the frame 32 of the base piece 20 can be received by the first channel 134 of the removable clip 14c. Force provided by the individual putting the reusable crate assembly 10 together is applied to the body 50 including by way of non-limiting example, the third arm 56, the fourth arm 58 or a combination thereof and brings a portion of the frame 32 of the second side piece 26 into the second channel 136 of the removable clip 14c. The curved portion 126 of the sixth arm 62 eases the entrance of the portion of the frame 32 of the second side piece 26 into the second channel 136. The curved portion 126 makes it easier for the removable clip 14a at the sixth arm 62 to slid over sharp corners of the second piece 142.

The removable clip 14c, having a G-shape, wraps around the base piece 20 and the second side piece 26 when fastened. That is, the removable clip 14c contacts six total surfaces. The first channel 134 contacts three surfaces of the base piece 20, where each of the three contacted surfaces is in a different plane than the other two. As used herein, the term “plane” is a two-dimensional space or flat surface that extends indefinitely. In other words, the three surfaces contacted by the removable clip 14c can include two parallel planes intersected by a third plane. Additionally, the second channel 136 contacts three surfaces of the second side piece 26, where each of the three contacted surfaces of the second side piece 26 define a different plane than the other two.

The removable clip 14c can be made of a material such a polymer or metal that has both strength benefits and provides a desired amount of flexibility. The flexibility of the removable clip 14c can also ease the installation of the wrap-around removable clip 14c, while the strength of the material provides a secure and durable fastener between the base piece 20 and the second side piece 26.

Optionally, additional removable clips, such as removable clip 14d can further secure the second side piece 26 to the base piece 20.

The first side piece 24 can be located with respect to the base piece 20 and the second side piece 26. The first channel 134 of the removeable clip 14a can be received by a portion of the frame 32 of the second side piece 26. A portion of the frame 32 of the first side piece 24 can be received by the second channel 136 of the removable clip 14a. Optionally, additional removable clips, such as removable clip 14b can further secure the first side piece 24 to the second side piece 26.

Similar to the second side piece 26, the fourth side piece 30 can couple to the base piece 20 and the first side piece 24 using one or more removable clip from the plurality of removable clips 14.

The third side piece 28 can couple to the second side piece 26 using one or more removable clip from the plurality of removable clips 14. Additionally, the third side piece 28 can couple to the fourth side piece 30 using one or more removable clip from the plurality of removable clips 14.

The lid piece 22 can couple to the second side piece 26 using one or more removable clip from the plurality of removable clips 14. Additionally, the lid piece 22 can couple to the fourth side piece 30 using one or more removable clip from the plurality of removable clips 14.

To disassemble the reusable crate assembly 10, an individual can use their hand or fingers to apply force to the finger grip 132 to remove each removable clip of the plurality of removable clips 14. The curved portion 126 of the sixth arm 62 eases the removal of the plurality of removable clips 14 when force is applied to the finger grips 132. Therefore, disassembly of the reusable crate assembly 10 can be completed by an individual without the use of tools.

FIG. 5 is a cross-sectional view of a removable clip 214 formed from one or more pieces of metal such a wire. The removable clip 214 is similar to the removable clip 14a of FIG. 3; therefore, like parts will be identified with like numerals increased by 200, with it being understood that the description of the like parts of the removable clip 14a applies to the removable clip 214, except where noted.

The removable clip 214 has a body 250. The body 250 includes a first arm 252, a second arm 254 extending from to the first arm 252, a third arm 256 extending from the second arm 254, a fourth arm 258 extending from the third arm 256, a fifth arm 260 extending from the fourth arm 258, and a spur arm or sixth arm 262 extending from the fifth arm 60.

The sixth arm 262, is illustrated the wire looped on itself. The sixth arm 262 extends from the fifth arm 260 at a portion that is between a first distal end 264 and a second distal end 266 of the fifth arm 260. The first arm 252, the second arm 254, the third arm 256, the fourth arm 258, and the fifth arm 260 form a G-shaped clip.

Aspects of the present disclosure provide a variety of benefits including that the removable clips are a tool free fastener. That is, without tools, a single individual can assemble the reusable crate assembly using the removable clips to couple adjacent pieces of the crate together. The reusable crate assembly can be shipped and a single individual who receives the reusable crate assembly can disassemble the crate, again, without the use of tools.

Another benefit is the wrap-around design in which the removable clip contacts six surfaces when applied. The wrap-around design provides increase security in the fastening of the pieces and the fastening of the removable clip to the pieces.

Another benefit is a lower cost to manufacture. The removable clip can be reused as it is not screwed, hammered, or otherwise applied to the reusable crate with a tool or fastener. Further, the removable clips can be made or cast from a polymer material, which are traditionally less expensive than clips made of metal. Polymers or plastics can provide an increase in flexibility at predetermined locations.

Yet another benefit is the set of spikes on the inside edge or the second surface of the second arm. The set of spurs provide pressure to the first piece, securing the first piece against the second piece in the clip.

The radius edge or curved portion of the sixth arm makes it easier for a hand to snap or push the removable clip into place. The radius edge or curved portion also makes it easier to release the removable clip via the finger grip.

Increased structure illustrated as the thickened portions at the first corner, the second corner, the third corner, the fourth corner, and/or the fifth corner provide additional strength and rigidity.

The finger grip allows a human hand to easily release or remove the removable clip with no tools.

The third angle is tapered; that is, the third angle is less than 90 degrees. The third angle allows for a tighter fit; pressing the fourth arm and the third arm against the first piece and the second piece.

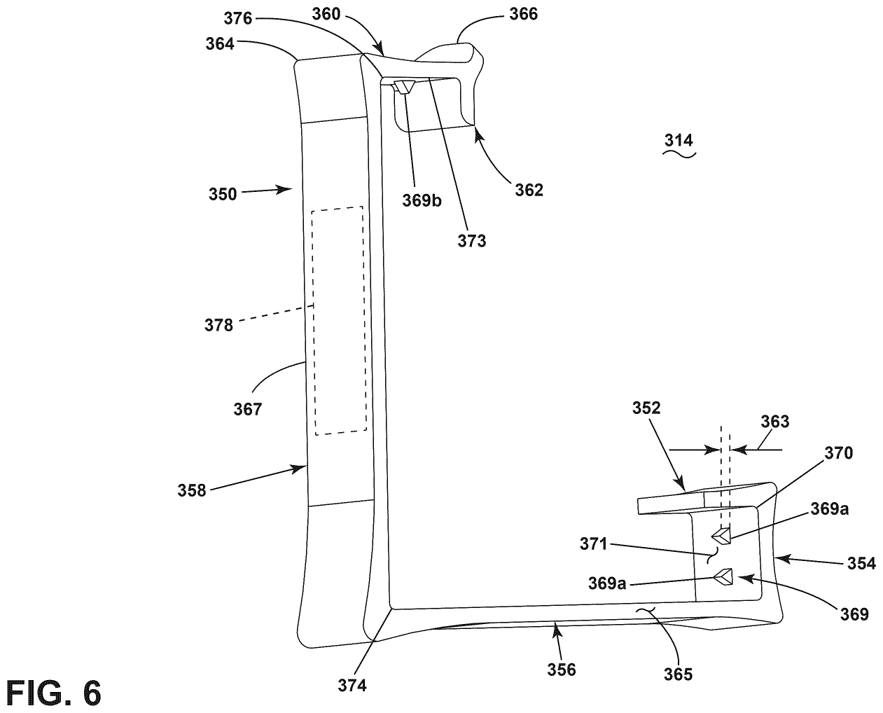

FIG. 6 illustrates a removable clip 314. The removable clip 314 is similar to the removable clip 14a of FIG. 2; therefore, like parts will be identified with like numerals increased by three hundred (300), with it being understood that the description of the like parts of the removable clip 14a applies to the removable clip 314, except where noted.

The removable clip 314 has a body 350. The body 350 includes a first arm 352, a second arm 354 extending from to the first arm 352, a third arm 356 extending from the second arm 354, a fourth arm 358 extending from the third arm 356, a fifth arm 360 extending from the fourth arm 358, and a spur arm or a sixth arm 362 provided on the fifth arm 360. The fifth arm 360 includes a first distal end 364 where it intersects with the fourth arm 358, and a second distal end 366, which is a free end. The sixth arm 362 extends from the fifth arm 360 at a portion that is between the first distal end 364 and the second distal end 366. The first arm 352, the second arm 354, the third arm 356, the fourth arm 358, and the fifth arm 360 form a G-shaped clip.

A first subset of spurs 369a of a set of spurs 369 extend from an interior surface 371 of the second arm 354. A second subset of spurs 369b of the set of spurs 369 extend from an interior surface 373 of the fifth arm 360. The second subset of spurs 369b can be located between the fourth arm 358 and the sixth arm 362. The set of spurs 369 can include any number of spurs or subsets of spurs. Further, while illustrated as extending from the second arm 354 and the fifth arm 360, it is contemplated that the first arm 352, third arm 356, fourth arm 358, and/or sixth arm 362 could include one or more spurs.

A spur length 363 can be measured in a direction L that extends perpendicular to a front face 365 of the body 350 and a rear face 367, opposite of the front face 365 of the body 350.

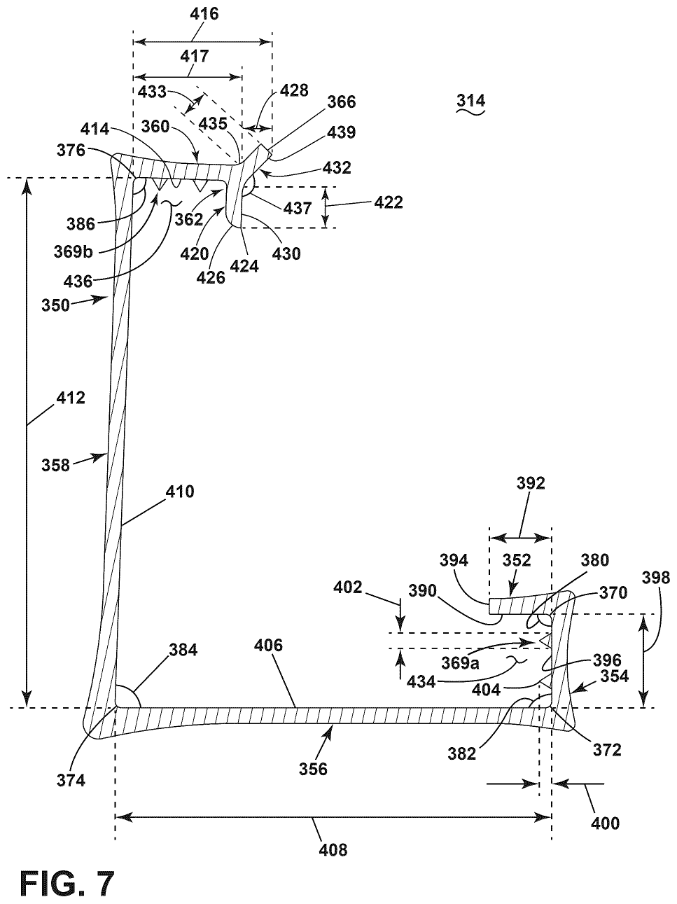

While illustrated as having a uniform size and shape, it is contemplated that that two or more spurs of the set of spurs 369 can have different sizes. For example, two or more spurs of the set of spurs 369 can have different heights, lengths, and/or widths as further described in FIG. 7. While illustrated as triangular prisms, it will be understood that this is by way of non-limiting example only and it is contemplated that any number of the set of spurs 369 can have any suitable shape, geometry, size, surface textures, or profile. Further still, by way of further non-limiting example, subsets of the set of spurs 369 can have different shapes, geometries, sizes, surface textures, or profiles. By way of additional non-limiting examples, one or more spurs of the set of spurs 369 can be a triangular pyramid, rectangular pyramid, or any regular or irregular pyramid. It is further contemplated that at least one spur of the set of spurs can have a cross section that is a rectangle, triangle, semi-circle, regular polygon, or irregular polygon.

A first corner 370 is defined in the body 350 where the first arm 352 extends from the second arm 354. That is, the first corner 370 is located at the intersection of the first arm 352 and the second arm 354. A second corner 372 is defined in the body 350 where the second arm 354 extends from the third arm 356. That is, the second corner 372 is located at the intersection of the second arm 354 and the third arm 356. A third corner 374 is defined in the body 350 where the third arm 356 extends from the fourth arm 358. That is, the third corner 374 is located at the intersection of the third arm 356 and the fourth arm 358. A fourth corner 376 is defined in the body 350 where the fourth arm 358 extends from the fifth arm 360. That is, the third corner 374 is located at the intersection of the fourth arm 358 and the fifth arm 360.

The removeable clip 314 can be unitary body or unitarily formed. That is, the body 350 can be a unitary monolithic body. It is contemplated that the body 350 can be formed by molded plastic. Further, it is contemplated that the body 350 can include at least one polymer. Additionally, or alternatively, the body 350 of the removeable clip 314 can include one or more of metal (e.g., steel, aluminum) or natural fiber where natural fiber can be produced by geological processes or from the bodies of plants or animals.

Optionally, the body 350 can include a feature 378. While illustrated as a single feature 378 in the fourth arm 358, it is contemplated that any number of features can be suitably located in any one or more arms. The feature 378 can be a recessed portion or can extend through the body 350 to create one or more windows. Alternatively, in another non-limiting example, the feature can be an embossment or raised portion of the body 350. By way of non-limiting example, the feature 378 can be a raised logo. In yet another different and non-limiting example, the feature 378 can be a thickened portion of the body 350. In yet a still further non-limiting example, the feature 378 can include a differing surface texture from a remainder of the surrounding body 350. It is further contemplated that one or more features can extend around corners. That is, the feature 378 can extend from at least one arm to another.

FIG. 7 is a cross sectional view of the removable clip 314 further illustrating the body 350. The first corner 370 defines a first angle 380, the second corner 372 defines a second angle 382, the third corner 374 defines a third angle 384, and the fourth corner 376 defines a fourth angle 386. The first angle 380, the second angle 382, the third angle 384, and the fourth angle 386 are between 10 degrees and 110 degrees. For example, the first angle 380, the second angle 382, and the fourth angle 386 can be in a range from 80 degrees to 100 degrees. By way of further non-limiting example, the first angle 380, the second angle 382, and the fourth angle 386 can be in a range from 85 degrees to 95 degrees.

The third angle 384 can be in a range from 20 degrees to less than 90 degrees. By way of example, the third angle 384 can be in a range from 70 degrees to less than 90 degrees.

It is contemplated that the third angle 384 can be less than one or more of the first angle 380, the second angle 382, and the fourth angle 386.

A first surface 390 is defined by an interior portion of the first arm 352. A length, illustrated as a first arm length 392, of the first arm 352 is measured from a first free end 394 to the first corner 370. By way of non-limiting example, the first arm length 392 can be measured along the first surface 390.

A second surface 396 is defined by an interior portion of the second arm 354. A length, illustrated as a second arm length 398, of the second arm 354 is measured from the first corner 370 to the second corner 372. By way of non-limiting example, the second arm length 398 can be measured along the second surface 396.

The second arm length 398 can be determined by a first thickness of a first piece of the two adjacent pieces to be held together by the removeable clip 314. By way of non-limiting example, the second arm length 398 can be within 10% or less of the first thickness. That is, the second arm length 398 can be within 10% or less of a finished or dressed first thickness of the first piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches. For example, the second arm length 398 can be within 5% or less of the first thickness. That is, the second arm length 398 can be within 5% or less of a finished or dressed first thickness of the first piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches.

As illustrated, by way of non-limiting example, the first arm length 392 can be less than the second arm length 398. Alternatively, in a different and non-limiting example, the first arm length 392 can be greater than the second arm length 398.

The first subset of spurs 369a are illustrated, by way of example, as located between the first corner 370 and the second corner 372. Each spur of the first subset of spurs 369a can include a spur height 400 and a spur width 402. The spur height 400 is measure from the surface from which the spur extends, illustrated as the second surface 396 to a spur peak 404 or portion of the spur extending farthest from the second surface 396. The spur height 400 can be in a range from 2% to 30% of the second arm length 398. For example, the spur height 400 can be in a range from 5% to 20% of the second arm length 398. In another non-limiting example, the spur height 400 can be in a range from 10% to 15% of the second arm length 398.

The spur width 402 can be measured along the second surface 396. The spur width 402 is the distance between the two points at which the spur intercepts the second surface 396.

The spur width 402 can be in a range from 2% to 50% of the second arm length 398. For example, the spur width 402 can be in a range from 10% to 30% of the second arm length 398. In another non-limiting example, the spur width 402 can be in a range from 15% to 20% of the second arm length 398. It is further contemplated that the spur width 402 can be in a range from 25% to 150% of the spur height 400. For example, the spur width 402 can be in a range from 50% to 150% of the spur height 400. In another non-limiting example, the spur width 402 can be in a range from 110% to 140% of the spur height 400.

The spur width 402 can be equal to the spur length 363 (FIG. 6). For example, the spur width 402 and the spur length 363 (FIG. 6) can be greater than the spur height 400. It is also contemplated in another example that the spur length 363 (FIG. 6) is greater than the spur height 400, the spur width 402, or both.

A third surface 406 is defined by an interior portion of the third arm 356. A length, illustrated as a third arm length 408, of the third arm 356 is measured from the second corner 372 to the third corner 374. By way of non-limiting example, the third arm length 408 can be measured along the third surface 406.

As illustrated, by way of non-limiting example, the third arm length 408 is greater than the first arm length 392 and the second arm length 398. It is contemplated that, for example, the third arm length 408 can be two to ten times longer than the first arm length 392. For example, the third arm length 408 can be six to eight times the first arm length 392. It is also contemplated that the third arm length 408 can be two to eight times the second arm length 398. For example, the third arm length 408 can be four to six times the second arm length 398.

The third arm length 408 can be determined by a first width of the first piece of the two adjacent pieces to be held together by the removeable clip 314. By way of non-limiting example, the third arm length 408 can be within 10% or less of the first width of the first piece. That is, the third arm length 408 can be within 10% or less of a finished or dressed first width of the first piece that can be, for example, 0.25, 0.5, 0.75, 1.0, 1.5, 3.5, 5.5, 7.25, 9.25, or 11.25 inches. For example, the third arm length 408 can be within 5% or less of the first width of the first piece. That is, the third arm length 408 can be within 5% or less of a finished or dressed first width of the first piece that can be, for example, 0.25, 0.5, 0.75, 1.0, 1.5, 3.5, 5.5, 7.25, 9.25, or 11.25 inches.

A fourth surface 410 is defined by an interior portion of the fourth arm 358. A length, illustrated as a fourth arm length 412, of the fourth arm 358 is measured from the third corner 374 to the fourth corner 376. By way of non-limiting example, the fourth arm length 412 can be measured along the fourth surface 410.

As illustrated, by way of non-limiting example, the fourth arm length 412 is greater than the third arm length 408, the second arm length 398, and the first arm length 392. Although this need not be the case. It is contemplated that, for example, the fourth arm length 412 can be two to twenty five times longer than the first arm length 392. By way of non-limiting example, the fourth arm length 412 can be six to ten times longer than the first arm length 392.

The fourth arm length 412 can be determined by a second width of a second piece of the two adjacent pieces to be held together by the removeable clip 314. By way of non-limiting example, the fourth arm length 412 can be within 10% or less of the second width of the second piece plus the first thickness of the first piece. That is, fourth arm length 412 can be within 10% or less of a finished or dressed second width of the second piece that can be, for example, 0.25, 0.5, 0.75, 1.0, 1.5, 3.5, 5.5, 7.25, 9.25, or 11.25 inches added to the first thickness of the first piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches. By way of further non-limiting example, the fourth arm length 412 can be within 5% or less of the second width of the second piece plus the first thickness of the first piece. That is, fourth arm length 412 can be within 5% or less of a finished or dressed second width of the second piece that can be, for example, 0.25, 0.5, 0.75, 1.0, 1.5, 3.5, 5.5, 7.25, 9.25, or 11.25 inches added to the first thickness of the first piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches.

A fifth surface 414 is defined by an interior portion of the fifth arm 360. A length, illustrated as a fifth arm length 416, of the fifth arm 360 is measured from the fourth corner 376 to a farthest extent of the second distal end 366 of the fifth arm 360. A fitted length 417 is measured between the fourth corner 376 to a sixth surface 420 of the sixth arm 362. The fitted length 417 can be measured along the fifth surface 414.

By way of non-limiting example, the fitted length 417 can be equal to the first arm length 392. Alternatively, the fitted length 417 can be between 50% and 250% of the first arm length 392. The second subset of spurs 369b can be located at the fifth surface 414 between the fourth arm 358 and the sixth arm 362. The second subset of spurs 369b can include any number of spurs. The second subset of spurs 369b can have equal dimensions to the first subset of spurs 369a. However, it is contemplated that one or more spurs of the second subset of spurs 369b can have a different spur width, spur height, or spur length. It is further contemplated that one or more spurs of the second subset of spurs 369b could have a different cross sectional shape than one or more of another spurs of the second subset of spurs 369b or one or more spurs of the first subset of spurs 369a. While illustrated as triangular prisms, it will be understood that this is by way of non-limiting example only and it is contemplated that any number of the set of spurs 369 can have any suitable shape, geometry, size, surface textures, or profile. Further still, by way of further non-limiting example, subsets of the set of spurs 369 can have different shapes, geometries, sizes, surface textures, or profiles. By way of additional non-limiting examples, one or more spurs of the set of spurs 369 can be a triangular pyramid, rectangular pyramid, or any regular or irregular pyramid. It is further contemplated that at least one spur of the set of spurs can have a cross section that is a rectangle, triangle, semi-circle, regular polygon, or irregular polygon.

The fitted length 417 can be determined by a second thickness of the second piece of the two adjacent pieces to be held together by the removeable clip 314. By way of non-limiting example, the fitted length 417 can be within 10% or less of the second thickness. That is, fitted length 417 can be within 10% or less of a finished or dressed second thickness of the second piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches. By way of further non-limiting example, the fitted length 417 can be within 5% or less of the second thickness. That is, fitted length 417 can be within 5% or less of a finished or dressed second thickness of the second piece that can be, for example, 0.125, 0.25, 0.375, 0.5, 0.625, 0.75, 1.0, 1.125, 1.25, 1.5, 1.75, 2.0, 2.25, 2.5, 2.75, 3.0, 3.25, or 3.5 inches.

The sixth surface 420 is defined by an interior portion of the sixth arm 362. A length, illustrated as a sixth arm length 422, of the sixth arm 362 is measured from the fifth surface 414 to a free end 424. The sixth arm length 422 is greater than the spur height 400.

The sixth arm length 422 is in a range of 5% to 100% of the first arm length 392. For example, the sixth arm length 422 can be in a range of 5% to 90%, 20% to 80%, 10% to 40%, 40% to 80% or 60% to 80% of the first arm length 392.

The sixth arm 362 can include a curved portion 426. The curved portion 426 can be adjacent or define apportion of the free end 124. The curved portion 426 has a radius of curvature greater than zero.

An inset length 428 is defined as the length between the second distal end 366 of the fifth arm 360 and an outer portion 430 of the sixth arm 362.

A grip 432 is defined by a portion of the fifth arm 360 between the outer portion 430 of the sixth arm 362 and the second distal end 366. A grip length 433 can be measured from an inflection 435 of the fifth arm 360 to the distal end 366. A grip angle 437 can be measured between the outer portion 430 of the sixth arm 362 and a grip surface 439 of the grip 432. It is contemplated that the grip length 433 or grip angle 437 can be suitably sized to accommodate at least a portion of a finger, thumb, or hand of a user.

A first channel 434 is defined by the first arm 352, the second arm 354, and the third arm 356. A second channel 436 is defined by the fourth arm 358, the fifth arm 360, and the sixth arm 362.

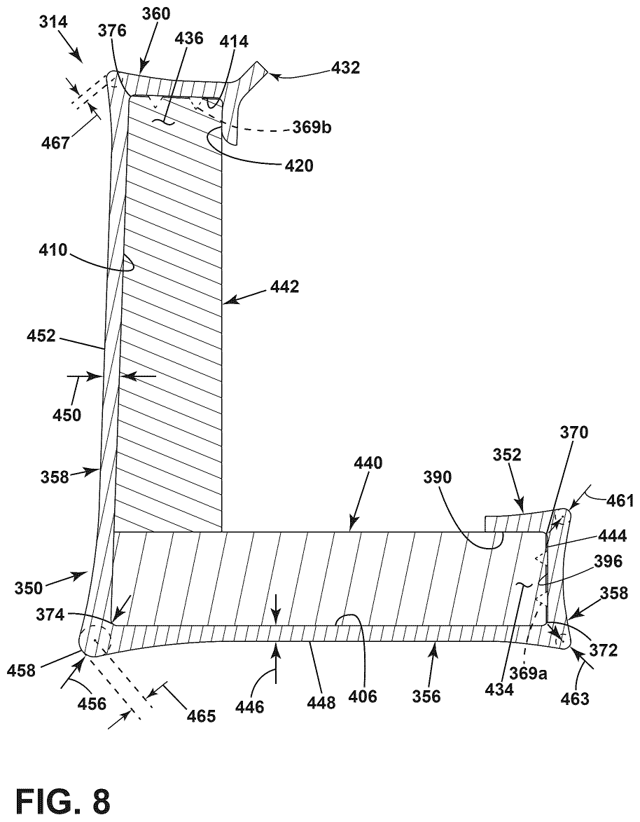

FIG. 8 further illustrates the removable clip 314 in a mounted position or assembled with a first piece 440 and a second piece 442. The first piece 440 and the second piece 442 can, for example, be lumber approximately 2 inches by 4 inches as sawed and usually 1.5 inches by 3.5 inches when dressed. By way of further non-limiting example, the first piece 440 or the second piece can be lumber approximately 1 inch by 2 inches, 2 inches by 6 inches, 4 inches by 4 inches, or 2 inches by 8 inches, as sawed. Further, the first piece 440 or the second piece 442 can include or be a panel, a plywood sheet, or a portion of a plywood sheet having a thickness, for example, of 0.125, 0.25, 0.375, 0.5, 0.625, 0.75, 1.125, or 1.25 inches. While illustrated as lumber, the first piece 440 or the second piece 442 can have any dimensions and be made entirely from or include portions of that are plastic, wood, or metal. That is, the removable clip 314 is coupling adjacent frames 32 (FIG. 1) illustrated as a first piece 440 and a second piece 442, adjacent to the first piece 440. The first channel 434 receives the first piece 440. In other words, when the removable clip 314 is coupling the first piece 440 and the second piece 442, the first surface 390, the second surface 396 and the third surface 406 are adjacent portions the first piece 440.

The second channel 436 receives the second piece 442. In other words, when the removable clip 314 is coupling the first piece 440 and the second piece 442, the fourth surface 410, the fifth surface 414, and the sixth surface 420 are adjacent, facing, and/or in contact with portions the second piece 442.

The first piece 440 includes a piece distal end 444 that is received by the first channel 434. When the removable clip 314 is fastened to the first piece 440 and the second piece 442, the first subset of spurs 369a can pierce, detent, or extend into the first piece 440 past the piece distal end 444. Additionally, or alternatively, the pieced distal end 444 contacts the second surface 396. Alternatively, the first subset of spurs 369a can be in contact the distal end 444 without piercing.

While illustrated as maintaining shape and size, it is contemplated that one or more spurs of the first subset of spurs 369a and/or the second set of spurs 369b can be mailable, That is, the at least one or more of the spurs of the first subset of spurs 369a and/or the second set of spurs 369b can bend, flex, or otherwise deform when the first piece 440 and the second piece 442 are fastened by the removable clip 314.

A third wall thickness 446 can be measured from the third surface 406 to an outer surface 448 of the third arm 356. Similarly, a fourth wall thickness 450 can be measured from the fourth surface 410 to an outer surface 452 of the fourth arm 358. A third corner thickness 456 can be measured from the intersection of the third surface 406 and the fourth surface 410 to an outer surface 458 of the third corner 374. The third corner thickness 456 can be greater than the third wall thickness 446 and the fourth wall thickness 450. That is, the body 350 can included thickened portions at the third corner 374. Further, as illustrated by way of example, the body 350 can included thickened portions at the first corner 370, the second corner 372, the third corner 374, and the fourth corner 376. It is contemplated that any or all of the first corner 370, the second corner 372, the third corner 374, or the fourth corner 376 can include additional material or thickened portions. The thickened portions can be formed as part of the monolithic body 350. Alternatively, the additional material or thickened portions can be coupled to the body 350 at any location.

A first radius of curvature 461 can be measured at the first corner 370 at the intersection of an outer surface of the first arm 352 and an outer surface the second arm 354. The first radius of curvature 461 can be in a range of 25% to 100% of the spur width 402 or in a range from 1% to 25% of the first arm length 392 (FIG. 7).

A second radius of curvature 463 can be measured at the second corner 372 at the intersection of an outer surface of the second arm 354 and the outer surface 448 of the third arm 356. The second radius of curvature 463 can be equal to the first radius of curvature 461. Alternatively, the second radius of curvature 463 can be greater than or less than the first radius of curvature 461.

A third radius of curvature 465 can be measured at the third corner 374 at the intersection of the outer surface 448 of the third arm 356 and the outer surface 452 of the fourth arm 358. The third radius of curvature 465 can be greater than the first radius of curvature 461, the second radius of curvature 463, or both the first radius of curvature 461 and the second radius of curvature 463. The third radius of curvature 465 can be in a range of 50% to 150% of the spur width 402 or in a range of 10% to 80% of the first arm length 392 (FIG. 7). For example, the third radius of curvature 465 can be in a range of 15% to 30% of the first arm length 392 (FIG. 7).

A fourth radius of curvature 467 can be measured at the fourth corner 376 at the intersection of the outer surface 452 of the fourth arm 358 and an outer surface of the fifth arm 360. The fourth radius of curvature 467 can be equal to the first radius of curvature 461, the second radius of curvature 463, or both the first radius of curvature 461 and the second radius of curvature 463. Alternatively, the fourth radius of curvature 467 can be different from the first radius of curvature 461, the second radius of curvature 463, or both the first radius of curvature 461 and the second radius of curvature 463.

Similar to the finger grip 132 (FIG. 3), the grip 432 can be used to couple or uncouple the removable clip 314 from the first piece 440 and the second piece 442. For example, when the removable clip 314 fastens the first piece 440 and the second piece 442, force can be applied to at least the grip 432 to uncouple or unfasten the removable clip 314 from first piece 440 and/or the second piece 442.

While the invention has been specifically described in connection with certain specific embodiments thereof, it is to be understood that this is by way of illustration and not of limitation. Reasonable variation and modification are possible with the scope of the foregoing disclosure and drawings without departing from the spirit of the invention which, is defined in the appended claims. Hence, specific dimensions and other physical characteristics relating to the embodiments disclosed herein are not to be considered as limiting, unless the claims expressly state otherwise.

Further aspects of the disclosure are provided by the subject matter of the following clauses:

A removable clip for fastening together a first piece adjacent to a second piece to form a portion of a crate, the removable clip comprising a body, the body comprising a first arm, a second arm coupled to the first arm, defining a first corner, a third arm coupled to the second arm, defining a second corner, a fourth arm coupled to the third arm, defining a third corner, a fifth arm, having a first distal end and a second distal end, wherein the first distal end of the fifth arm is coupled to the fourth arm, defining a fourth corner, and a sixth arm provided on the fifth arm between the first distal end and the second distal end, wherein the first arm, the second arm, and the third arm define a first channel that receives the first piece, and wherein the fourth arm, the fifth arm, and the sixth arm define a second channel that receives the second piece.

The removable clip of any preceding clause, wherein an inset length is defined as a length between the second distal end of the fifth arm and an outer portion of the sixth arm.

The removable clip of any preceding clause, wherein a portion of the fifth arm between the second distal end of the fifth arm and the outer portion of the sixth arm defines a finger grip or grip.

The removable clip of any preceding clause, wherein a length of the first arm is measured from a first free end to the first corner and a length of the fifth arm is measured from the first distal end to the second distal end of the fifth arm, wherein the length of the fifth arm is between 50% and 200% of the length of the first arm.

The removable clip of any preceding clause, wherein a length of the sixth arm is measured from a second free end to the fifth arm, wherein the length of the sixth arm is between 5% and 100% of the length of the fifth arm.

The removable clip of any preceding clause, wherein the length of the sixth arm is between 10% and 50% of the length of the fifth arm.

The removable clip of any preceding clause, wherein the second arm includes a set of spurs between the first corner and the second corner.

The removable clip of any preceding clause, wherein the set of spurs extend a spur height from a second surface defined by the second arm, wherein the spur height is less than 15% of a length of the second arm measured from the first corner to the second corner.

The removable clip of any preceding clause, wherein the first arm, the second arm, the third arm, the fourth arm, and the fifth arm form a G-shaped clip.

The removable clip of any preceding clause, wherein the body comprises thickened portions at the first corner, the second corner, the third corner, and the fourth corner.

The removable clip of any preceding clause, wherein each of the first corner, the second corner, the third corner, and the fourth corner define an angle between 10 degrees and 110 degrees.

The removable clip of any preceding clause, wherein the angle defined by the third corner is in a range from 20 degrees to less than 90 degrees.

The removable clip of any preceding clause, wherein the body is a unitary monolithic body.

The removable clip of any preceding clause, wherein the body includes a material that is one or more of a polymer, a natural fiber, or a metal.

A removable clip for fastening together a first piece adjacent to a second piece to form a portion of a crate, the removable clip comprising a body comprising a first arm, defining a first surface, a second arm defining a second surface, wherein the second arm is coupled to the first arm, a third arm defining a third surface, wherein the third arm is coupled to the second arm, a fourth arm defining a fourth surface, wherein the fourth arm is coupled to the third arm, a fifth arm, defining a fifth surface, wherein the fifth arm has a first distal end and a second distal end, wherein the first distal end of the fifth arm is coupled to the fourth arm, and a sixth arm, defining a spur surface, wherein the sixth arm is provided on the fifth arm between the first distal end and the second distal end, wherein when the body is clipped to the first piece and the second piece, the first surface, the second surface and the third surface are adjacent portions the first piece, and wherein the fourth surface the fifth surface, and the spur surface are adjacent portions the second piece.

The removable clip of any preceding clause, wherein the body is a unitary body.

The removable clip of any preceding clause, wherein the body further comprises a finger grip or grip having an inset length defined between the second distal end of the fifth arm and an outer portion of the sixth arm.

The removable clip of any preceding clause, wherein the sixth arm includes a free end, and wherein a portion of the free end includes a curved portion.

The removable clip of any preceding clause, wherein a sixth arm length is measured from the free end to the fifth arm, wherein the sixth arm length is between 10% and 40% of a fifth arm length measured from the first distal end to the second distal end.

The removable clip of any preceding clause, wherein the body further comprises at least one spur extending a spur height from the second arm and located between a first corner and a second corner, wherein the spur height is less than the sixth arm length.

The removable clip of any preceding clause, wherein a sixth arm length is measured from the free end to the fifth arm, wherein the sixth arm length is between 20% and 80% of a fifth arm length measured from the first distal end to the second distal end.

The removable clip of any preceding clause, wherein the angle defined by the third corner is less than 90 degrees.

The removable clip of any preceding clause, wherein the second arm includes a set of spurs located between the first corner and the second corner, between the fourth corner and the sixth arm, or a combination thereof.

The removable clip of any preceding clause, wherein at least one spur of the set of spurs extend a spur height from a second surface defined by the second arm or a fifth surface defined by the fifth arm, wherein the spur height is less than 150% of a length of the second arm measured from the first corner to the second corner.

The removable clip of claim 2, wherein a portion of the fifth arm between the second distal end of the fifth arm and the outer portion of the sixth arm defines a grip length.

The removable clip of any preceding clause, wherein the set of spurs includes a first subset of spurs extending from a second surface defined by the second arm, and a second subset of spurs extending from a fifth surface defined by the fifth arm.

The removable clip of any preceding clause, wherein the set of spurs includes at least one spur with a triangular cross section.

The removable clip of any preceding clause, wherein the set of spurs includes at least one spur shaped as a triangular prism.

What is claimed is:

1. A removable clip for fastening together a first piece adjacent to a second piece to form a portion of a crate, the removable clip comprising:
a body comprising:
a first arm;
a second arm coupled to the first arm, defining a first corner;
a third arm coupled to the second arm, defining a second corner;
a fourth arm coupled to the third arm, defining a third corner;
a fifth arm, having a first distal end and a second distal end, wherein the first distal end of the fifth arm is coupled to the fourth arm, defining a fourth corner; and
a sixth arm provided on the fifth arm between the first distal end and the second distal end;
wherein the first arm, the second arm, and the third arm define a first channel that receives the first piece, and wherein the fourth arm, the fifth arm, and the sixth arm define a second channel that receives the second piece.

2. The removable clip of claim 1, wherein an inset length is defined as a length between the second distal end of the fifth arm and an outer portion of the sixth arm.

3. The removable clip of claim 2, wherein a portion of the fifth arm between the second distal end of the fifth arm and the outer portion of the sixth arm defines a grip length.

4. The removable clip of claim 1, wherein a length of the first arm is measured from a first free end to the first corner and a length of the fifth arm is measured from the first distal end to the second distal end of the fifth arm, wherein the length of the fifth arm is between 50% and 200% of the length of the first arm.

5. The removable clip of claim 4, wherein a length of the sixth arm is measured from a second free end to the fifth arm, wherein the length of the sixth arm is between 5% and 100% of the length of the fifth arm.

6. The removable clip of claim 5, wherein the length of the sixth arm is between 10% and 50% of the length of the fifth arm.

7. The removable clip of claim 1, wherein the second arm includes a set of spurs located between the first corner and the second corner, between the fourth corner and the sixth arm, or a combination thereof.

8. The removable clip of claim 7, wherein at least one spur of the set of spurs extend a spur height from a second surface defined by the second arm or a fifth surface defined by the fifth arm, wherein the spur height is less than 15% of a length of the second arm measured from the first corner to the second corner.

9. The removable clip of claim 1, wherein the first arm, the second arm, the third arm, the fourth arm, and the fifth arm form a G-shaped clip.

10. The removable clip of claim 1, wherein the body comprises thickened portions at the first corner, the second corner, the third corner, and the fourth corner.

11. The removable clip of claim 1, wherein each of the first corner, the second corner, the third corner, and the fourth corner define an angle between 10 degrees and 110 degrees.

12. The removable clip of claim 11, wherein the angle defined by the third corner is less than 90 degrees.

13. The removable clip of claim 1, wherein the body is a unitary monolithic body.

14. The removable clip of claim 1, wherein the body includes a material that is one or more of a polymer, a natural fiber, or a metal.

15. A removable clip for fastening together a first piece adjacent to a second piece to form a portion of a crate, the removable clip comprising:
a body comprising:
a first arm, defining a first surface;
a second arm defining a second surface, wherein the second arm is coupled to the first arm;
a third arm defining a third surface, wherein the third arm is coupled to the second arm;
a fourth arm defining a fourth surface, wherein the fourth arm is coupled to the third arm;
a fifth arm, defining a fifth surface, wherein the fifth arm has a first distal end and a second distal end, wherein the first distal end of the fifth arm is coupled to the fourth arm; and
a sixth arm, defining a spur surface, wherein the sixth arm is provided on the fifth arm between the first distal end and the second distal end;
wherein when the body is clipped to the first piece and the second piece, the first surface, the second surface and the third surface are adjacent portions the first piece, and wherein the fourth surface the fifth surface, and the spur surface are adjacent portions the second piece.

16. The removable clip of claim 15, wherein the body is a unitary body.

17. The removable clip of claim 15, wherein the body further comprises a grip having an inset length defined between the second distal end of the fifth arm and an outer portion of the sixth arm.

18. The removable clip of claim 15, wherein the sixth arm includes a free end, and wherein a portion of the free end includes a curved portion.

19. The removable clip of claim 18, wherein a sixth arm length is measured from the free end to the fifth arm, wherein the sixth arm length is between 20% and 80% of a fifth arm length measured from the first distal end to the second distal end.

20. The removable clip of claim 19, wherein the body further comprises at least one spur extending a spur height from the second arm and located between a first corner and a second corner, wherein the spur height is less than the sixth arm length.
